(19) United States
(12) Patent Application Publication
(10) Pub. No.: US 2025/0281351 A1
(43) Pub. Date: Sep. 11, 2025

(54) HEAD-MOUNTED CLAMPING-TYPE HEAD MASSAGE DEVICE

(71) Applicant: Zhijun PENG, Foshan (CN)

(72) Inventor: Zhijun PENG, Foshan (CN)

(21) Appl. No.: 18/979,675

(22) Filed: Dec. 13, 2024

(30) Foreign Application Priority Data
Mar. 6, 2024 (CN) 2024102546061

(51) Int. Cl. A61H 23/02

(52) U.S. Cl. CPC A61H 23/0245; A61H 2201/105; A61H 2201/1604; A61H 2201/165; A61H 2201/1695; A61H 2205/02

(57) ABSTRACT

A head-mounted clamping-type head massage device, having two semi-spherical helmet shells, two ultrasonic vibrators and some massage heads; front ends of the two semi-spherical helmet shells as well as rear ends of the two semi-spherical helmet shells are in each case connected to each other via at least one binding belt; a plurality of through holes are formed on each of the two semi-spherical helmet shells; each massage head is selectively mounted on one of the through holes; the two ultrasonic vibrators are mounted on the two semi-spherical helmet shells respectively.

### BACKGROUND OF THE INVENTION

The present invention relates to the field of massage equipment for head healthcare, and in particular, to a head-mounted clamping-type head massage device.

Due to urbanization, more and more people move to cities where the pace of life is faster and the stress from work is greater. As a result, more and more people suffer from a sub-health condition. Accordingly, people have been paying more attention to their health, and hence various massage-based healthcare devices have been emerged to provide fatigue relief and to strengthen people's health. Among numerous massage-based healthcare devices, a head massage device can provide massage to a head to promote blood circulation, increase oxygen supply to the brain, and thus relieve brain fatigue, thereby achieving significantly pronounced effect on restoring user's body and mind conditions. The applicant has two prior art patents pertaining to a head massage device.

The first one is CN111345994B (application number 201811578373.1) titled “ULTRASONIC VITAL ENERGY AND BLOOD CIRCULATION MASSAGE HEALTHCARE HELMET DEVICE”. According to this prior art patent, surface mounted ultrasonic transducers and surface mounted air bags are used on an inner surface of the helmet. The ultrasonic transducers generate high-frequency ultrasonic vibration so that the head and the face are massaged, thereby achieving the objective of promoting blood flow and circulation in the head and the face, and hence promoting metabolism, bringing nutrients to the head, relieving headache, and even increasing the quantity and quality of hair growth. However, it also has the following deficiencies: Firstly, high-frequency vibration positions in the helmet are relatively fixed; and the positions for vibration cannot be adjusted freely by the user according to actual use requirements; as a result, the helmet cannot be used flexibly. Secondly, at least one ultrasonic transducer needs to be provided for one high-frequency vibration position; as a result, the quantity of ultrasonic transducers to be used is relatively large, wiring is massive and complicated, and hence leading to great manufacturing difficulty; moreover, when a plurality of ultrasonic transducers are used together, a large amount of electric energy is consumed; and the air bags also consume electric energy during operation; consequently, the entire head massage device consumes a lot of electricity and is not energy saving. Thirdly, the force of the air bags pressing against the head and/or face cannot be adjusted; as a result, the requirement of using different forces by different users for high-frequency ultrasonic vibratory massage cannot be met.

The second one is CN212439337U (application number 202020600939.2) titled “ULTRASONIC HEAD MASSAGE, PHYSIOTHERAPY, AND MEDICINE APPLICATION DEVICE IN FORM OF 3D ENCLOSURE OF THE HEAD BY AIR BAGS”. According to this prior art patent, a head accommodating shell is disposed on an ultrasonic vibration base; medicine physiotherapy concave cavities are formed inside the head accommodating shell, so that simultaneous therapies of ultrasonic vibratory massage and steaming of medicine are realized to enhance the effect of massage-based physiotherapy. However, it also has the following deficiencies: Firstly, the size of the ultrasonic vibration base is relatively large, and its structure is complicated. Secondly, the device can be used only when the user lies down, and cannot be worn and used when the user is sitting, standing, or walking; as a result, the device is inconvenient to use.

Based on the deficiencies of the foregoing two prior art patents, the applicant considers that there are room for improvements of head massage devices to better satisfy daily massage-based healthcare needs of users.

### BRIEF SUMMARY OF THE INVENTION

To resolve the foregoing problems and deficiencies, the present invention provides a head-mounted clamping-type head massage device. The head-mounted clamping-type head massage device of the present invention is small in size, can be clamped to the head of a human body, and can be worn and used when a user is sitting, standing, or walking, thereby allowing the user to perform other tasks during massage. Moreover, a plurality of massage heads on a corresponding one of two semi-spherical helmet shells are driven synchronously to perform high-frequency vibratory massage by powering on a corresponding one of the two ultrasonic vibrators to operate, thereby reducing the quantities of electric elements and connection wires being used, simplifying the structure and manufacturing process, and saving electric energy. Further, the plurality of massage heads on both the semi-spherical helmet shells can be detached. Therefore, the objective of adjusting positions of the massage heads can be achieved; use of the device is more flexible and convenient; and the requirement of user for massaging different positions of the head can be met.

The technical solutions of the present invention are achieved as follows: A head massage device, comprising two semi-spherical helmet shells symmetrically arranged side by side; each of the two semi-spherical helmet shells is provided with an eye-nose-mouth outlet hole and an ear outlet hole; front ends of the two semi-spherical helmet shells as well as rear ends of the two semi-spherical helmet shells are in each case connected to each other via at least one binding belt, so that the two semi-spherical helmet shells are connected as a whole; a work cavity that can be narrowed and tightened by said at least one binding belt between the front ends of the two semi-spherical helmet shells and said at least one binding belt between the rear ends of the two semi-spherical helmet shells is formed between the two semi-spherical helmet shells; the head massage device also comprises two ultrasonic vibrators and a plurality of massage heads; a plurality of through holes spaced apart from one another evenly by a same distance are formed on each of the two semi-spherical helmet shells; each of the plurality of massage heads is detachably and adjustably mounted in a respective one of the through holes via threaded connection; the two ultrasonic vibrators are mounted on the two semi-spherical helmet shells respectively, and when powered on, each of the two ultrasonic vibrators drives all the massage heads on a corresponding one of the two semi-spherical helmet shells to synchronously perform high-frequency vibratory massage.

Further, a concave cavity is formed in the middle of each of the two semi-spherical helmet shells; each concave cavity is disposed with a corresponding one of the two ultrasonic vibrators, and a cover for protecting the corresponding one of the ultrasonic vibrators is provided for each concave cavity to cover an opening of each concave cavity.

Further, a control panel is disposed on only one cover; a control circuit board electrically connected to a corresponding one of the two ultrasonic vibrators and said control panel is disposed on an inner side of each cover.

Further, each of the massage heads comprises a massage part with a surface featuring a plurality of massage protrusions, a screw part having one end connected to the massage part, and two tightening nuts; the screw part is selectively inserted into one of the through holes, and the two tightening nuts are screwed onto the screw part on both sides of said one of the through holes respectively, thereby allowing the screw part to be detachably and adjustably installed into said one of the through holes.

The present invention has the following beneficial effects: (1) According to the present invention, two semi-spherical helmet shells are provided, and binding belts are used to narrow and tighten a work cavity, so that the head massage device of the present invention has a small size and a simple structure, and can be very conveniently clamped to the head of the human body to perform ultrasonic vibratory massage around the head. In addition, a person can use the head massage device while sitting, standing, or walking, so that the user is allowed to perform other tasks during head massage therapy, in other words, massage and other work tasks can co-exist simultaneously. (2) According to the head massage device of the present invention, the two semi-spherical helmet shells are each being driven to perform high-frequency vibration by powering on a corresponding ultrasonic vibrator, so that the massage heads on the corresponding semi-spherical helmet shell are driven synchronously to perform high-frequency vibratory massage, thereby greatly reducing the quantity of ultrasonic vibrators to be used and the connection wires required, simplifying the structure and manufacturing process, and saving electric energy. (3) Because the massage heads are adjustably threaded to through holes in the two semi-spherical helmet shells, when the user wears the device, the force of the massage heads pressing against the head can be adjusted by screwing the massage heads. Therefore, the massage heads can press tightly against the head to provide a high-frequency ultrasonic vibratory massage with relatively strong force. This allows the user to adjust the pressing force of the massage heads based on his/her own needs, so that the head massage device can meet the use requirements of a majority of users and has a wider scope of application. (4) Because the massage heads are detachably threaded to the through holes in each of the two semi-spherical helmet shells, a massage head can be detached from a through hole and then mounted in another through hole at a position corresponding to the position that needs to be massaged. Therefore, the objective of adjusting the vibration position freely is achieved; use of the device is very flexible and convenient; and massage requirements of users for different head positions can be met effectively. (5) Because each of the two semi-spherical helmet shells is provided with an eye-nose-mouth outlet hole, and a distance between the two eye-nose-mouth outlet holes can be adjusted by adjusting the binding belts at the front ends of the two semi-spherical helmet shells, the head massage device can be suitable for various eye-nose-mouth sizes. Therefore, the scope of application is wider. Moreover, due to the structural design of the eye-nose-mouth outlet holes and the ear outlet holes, the eyes, the nose, the mouth, and the ears of the user can be prevented from being enclosed in the head massage device, so that the problems of difficulty in breathing, difficulty in eye opening, and hindrance to hearing are avoided.

### BRIEF DESCRIPTION OF THE DRAWINGS

FIG. 1 is a schematic front perspective structural view of a head-mounted clamping-type head massage device according to the present invention.

FIG. 2 is a schematic rear perspective structural view of the head-mounted clamping-type head massage device according to the present invention.

FIG. 3 is a schematic sectional structural view along section A-A of FIG. 2.

### DETAILED DESCRIPTION OF THE INVENTION

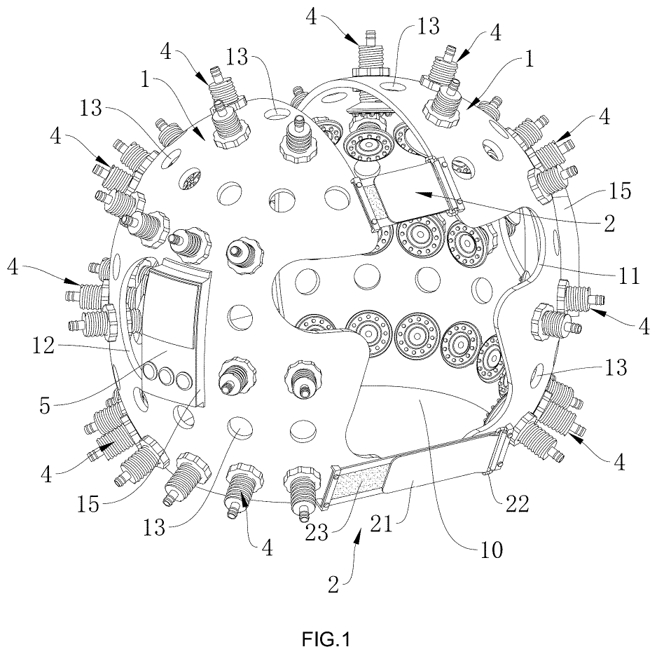

As shown in FIG. 1 to FIG. 3, the present invention provides a head-mounted clamping-type head massage device, comprising two semi-spherical helmet shells 1 symmetrically arranged side by side; each of the two semi-spherical helmet shells 1 is provided with an eye-nose-mouth outlet hole 11 and an ear outlet hole 12; front ends of the two semi-spherical helmet shells 1 as well as rear ends of the two semi-spherical helmet shells 1 are in each case connected to each other via at least one binding belt 2, so that the two semi-spherical helmet shells 1 are connected as a whole; a work cavity 10 that can be narrowed and tightened by said at least one binding belt 2 between the front ends of the two semi-spherical helmet shells 1 and said at least one binding belt 2 between the rear ends of the two semi-spherical helmet shells 1 is formed between the two semi-spherical helmet shells 1; the head massage device also comprises two ultrasonic vibrators 3 and a plurality of massage heads 4; a plurality of through holes 13 spaced apart from one another evenly by a same distance are formed on each of the two semi-spherical helmet shells 1; each of the plurality of massage heads 4 is detachably and adjustably mounted in a respective one of the through holes 13 via threaded connection; the two ultrasonic vibrators 3 are mounted on the two semi-spherical helmet shells 1 respectively, and when powered on, each of the two ultrasonic vibrators 3 drives all the massage heads 4 on a corresponding one of the two semi-spherical helmet shells 1 to synchronously perform high-frequency vibratory massage.

The head-mounted clamping-type head massage device of the present invention is small in size, can be clamped to the head of a human body, and can be worn and used when a user is sitting, standing, or walking, thereby allowing the user to perform other tasks during massage. Moreover, the plurality of massage heads 4 on a corresponding one of the two semi-spherical helmet shells 1 are driven synchronously to perform high-frequency vibratory massage by powering on a corresponding one of the two ultrasonic vibrators 3 to operate, thereby reducing the quantities of electric elements and connection wires being used, simplifying the structure and manufacturing process, and saving electric energy. Further, the plurality of massage heads 4 on both the semi-spherical helmet shells 1 can be detached. Therefore, the objective of adjusting positions of the massage heads 4 can be achieved; use of the device is more flexible and convenient; and the requirement of user for massaging different positions of the head can be met.

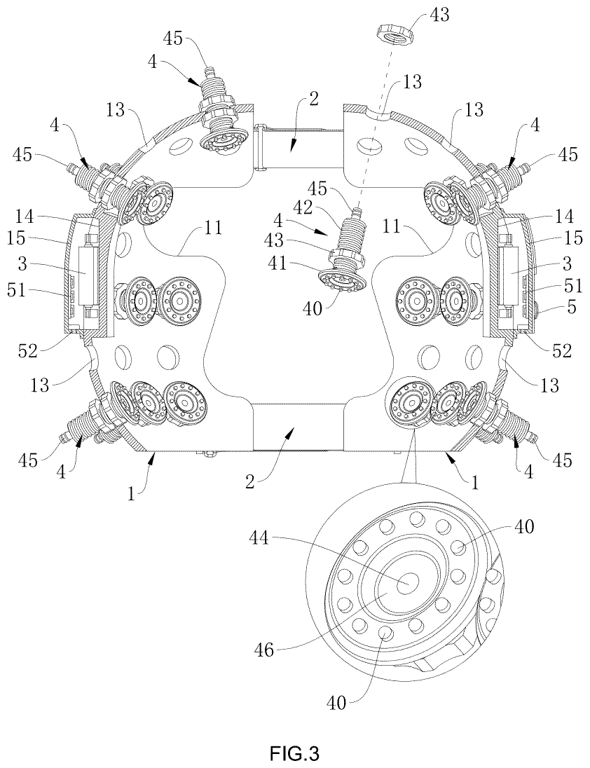

To avoid the two ultrasonic vibrators 3 from being exposed to an external environment, and to improve the surface tidiness and safety of use of the head massage device, as shown in FIG. 3, a concave cavity 14 is formed in the middle of each of the semi-spherical helmet shells 1; each concave cavity 14 is disposed with a corresponding one of the two ultrasonic vibrators 3, and a cover 15 for protecting the corresponding one of the ultrasonic vibrators 3 is provided for each concave cavity 14 to cover an opening of each concave cavity 14. The ultrasonic vibrators 3 can be encapsulated effectively by providing the covers 15 to achieve a dust-proof effect. Moreover, during use of the head massage device of the present invention, the human body cannot touch the ultrasonic vibrators 3, so that the safety of use of the head massage device is improved. In addition, the concave cavities 14 formed in the middle of the semi-spherical helmet shells 1 respectively allow the high-frequency vibration of each of the two ultrasonic vibrators 3 on a corresponding one of the two semi-spherical helmet shells 1 to be uniformly transferred to all positions of the corresponding semi-spherical helmet shell 1, thereby ensuring that the vibration kinetic energy applied to the massage heads 4 on each of the two semi-spherical helmet shells 1 will be nearly the same, thereby ensuring that all massaging zones on the head massage device can provide a relatively balanced ultrasonic vibratory massage effect.

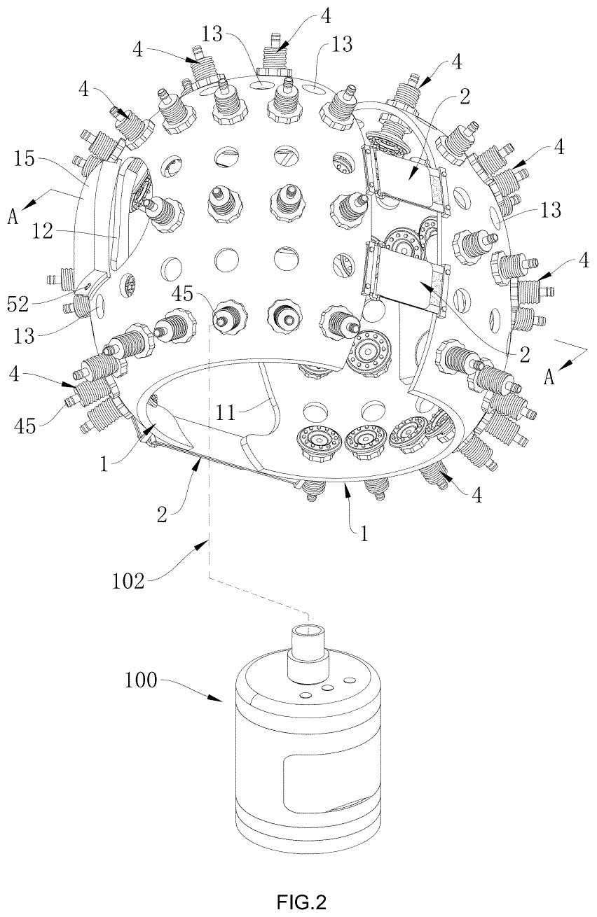

To enable the user to use the head massage device conveniently, as shown in FIG. 1 and FIG. 3, a control panel 5 is disposed on only one cover 15; a control circuit board 51 electrically connected to a corresponding one of the two ultrasonic vibrators 3 and said control panel 5 is disposed on an inner side of each cover 15. As shown in FIG. 1 and FIG. 2, in the present invention, the control panel 5 may be disposed only on the cover 15 of one of the two semi-spherical helmet shells 1; the ultrasonic vibrator 4 on another one of the two semi-spherical helmet shells 1 not provided with the control panel 5 may be connected to the control panel 5 via wired or wireless connection so that the control panel 5 also controls the operation of the ultrasonic vibrator 3 on said another one of the two semi-spherical helmet shells 1. Each of the two ultrasonic vibrators 3 is an ultrasonic vibration motor or an ultrasonic transducer. When the ultrasonic transducer is used, each control circuit board 51 of the present invention is further provided with an ultrasonic generator or an ultrasonic generating circuit; and the ultrasonic generator or the ultrasonic generating circuit drives the corresponding ultrasonic transducer to work. As shown in FIG. 1, to facilitate the user to operate the control panel 5 more easily and smoothly, both the concave cavity 14 and the cover 15 on each of the semi-spherical helmet shells 1 are located at a front side of a corresponding ear outlet hole 12.

As shown in FIG. 3, to facilitate power supply to different electric elements, each cover 15 is further provided with a power interface 52 electrically connected to a corresponding control circuit board 51. Of course, the head massage device of the present invention can also be provided with storage batteries for power supply. In addition, a Bluetooth® communication module or a Wi-Fi® communication module can also be provided in each control circuit board 51, and corresponding application software can be developed and installed on a smartphone so that the head massage device of the present invention can be controlled to operate by using the smartphone. Alternatively, an infrared communication module can be provided to each control circuit board 51, thereby allowing the head massage device to be operated using a remote controller.

To ensure that the massage heads 4 are simple in structure, easy to implement, and convenient to produce and manufacture, as shown in FIG. 3, each of the massage heads 4 comprises a massage part 41 with a surface featuring a plurality of massage protrusions 40, a screw part 42 having one end connected to the massage part 41, and two tightening nuts 43; the screw part 42 is selectively inserted into one of the through holes 13, and the two tightening nuts 43 are screwed onto the screw part 42 on both sides of said one of the through holes 13 respectively, thereby allowing the screw part 42 to be detachably and adjustably installed into said one of the through holes 13. Through clamping by the two tightening nuts 43, each of the massage heads 4 can be securely installed on a corresponding one of the two semi-spherical helmet shells 1, making it less likely to be loosen or detached. As shown in FIG. 3, during detachment, it is only necessary to unscrew the tightening nut 43 proximal to an outer end (i.e. “another end” as described below) of the screw part 42 from the screw part 42, so that the screw part 42 can be detached from the through hole 13 and thereby removing the entire massage head 4 from the corresponding semi-spherical helmet shell 1. When it is necessary to adjust the massage head 4 to press against the human body, adjustment can be achieved simply by holding the massage part 41 or the screw part 42 and then screwing the two tightening nuts 43 to adjust the positions of the two tightening nuts 43.

To increase the functionality of the head massage device of the present invention, as shown in FIG. 1, FIG. 2, and FIG. 3, a drug supply channel 44 is provided on each of the massage heads 4 penetrating from the surface of the massage part 41 provided with the plurality of massage protrusions 40 all the way through said one end of the screw part 42 along an axial direction of the screw part 42 through another end of the screw part 42; said another end of the screw part 42 distal from the massage part 41 is also provided with an interface part 45 connected to the drug supply channel 44. Through the design of the drug supply channel 54 and the interface part 35, the head massage device of the present invention can be sold together with a drug supply device 100. The drug supply device 100 is selectively connected to at least one interface part 55 through at least one pipeline 102, and drug solutions can be converted to gaseous drug by the drug supply device 100 which then pumps the gaseous drug to at least one corresponding drug supply channel 34 through which the gaseous drug is sprayed onto the human body, thereby achieving a therapeutic effect through steaming of the gaseous drug. An example of the drug supply device 100 is mentioned in CN111939045A (application number 201910413695.9) also proposed by the inventor of the present invention.

As shown in FIG. 1 and FIG. 3, the massage part 41 is also provided with a recess 46, and the drug supply channel 44 penetrates through a bottom surface of the recess 46; the plurality of massage protrusions 40 are arranged circumferentially around the recess 46. Through these designs, an outlet of the drug supply channel 44 is prevented from being blocked by the skins and flesh of human body which may move and hence block the drug supply channel 44 when the massage part 41 presses against the human body to perform massage. Through the arrangement of the recess 46, the drug supply channel 44 is spaced apart from the human body to effectively prevent blockage of the drug supply channel 44. By arranging the massage protrusions 40 circumferentially around the recess 46, gaps between adjacent massage protrusions 40 facilitate the outward diffusion of the gaseous drug, thereby ensuring smooth outflow of the gaseous drug.

As shown in FIG. 1 and FIG. 2, said at least one binding belt 2 connecting the front ends of the two semi-spherical helmet shells 1 comprises two binding belts 2, and said at least one binding belt 2 connecting the rear ends of the two semi-spherical helmet shells 1 comprises two binding belts 2, therefore a total number of binding belts provided is four. Accordingly, the two semi-spherical helmet shells 1 can be stably connected together and are not easy to get loose. Moreover, when wearing the head massage device of the present invention, the front ends of the semi-spherical helmet shells 1 are already connected by the binding belts prior to wearing such that the user may wear the head massage device from a front side of the head and then connect the binding belts 2 at the rear ends of the semi-spherical helmet shells 1; alternatively, the rear ends of the semi-spherical helmet shells 1 are already connected by the binding belts prior to wearing such that the user may wear the head massage device from a rear side of the head and then connect the binding belts 2 at the front ends of the semi-spherical helmet shells 1. As shown in FIG. 2, the two binding belts 2 at the front ends of the two semi-spherical helmet shells 1 are located above and beneath the eye-nose-mouth outlet holes 11 respectively. As such, the binding belts 2 can be prevented from covering the eye-nose-mouth outlet holes 11, thereby preventing the binding belts 2 from interfering with the eyes, nose, and mouth during use and thus ensuring the comfort of use.

To ensure that each binding belt 2 is simple in structure and easy to implement, as shown in FIG. 1, each binding belt 2 comprises a connecting belt 21 disposed on one of the two semi-spherical helmet shells 1, and a binding belt ring 22 disposed on another one of the semi-spherical helmet shells 1; as shown in FIG. 1, a hook and loop fastener 23 is disposed on an outer side surface of the connecting belt 21; and one end of the connecting belt 21 passes through the binding belt ring 22 and is then folded back and adhered back to the outer side surface of the connecting belt 21. “Adhered back to the surface of the connecting belt 21” herein refer to self-adhesion of a loop part and a hook part of the hook and loop fastener 23 already known in the art. Due to such structural design, a distance between the two semi-spherical helmet shells 1 can be adjusted, and thus, the head massage device can adapt to various head sizes and the scope of utility becomes wider.

During application, a quantity of the massage heads 4 mounted on the two semi-spherical helmet shells 1 can be increased or decreased freely by individual users according to their own needs; distribution positions of the massage heads 4 on the two semi-spherical helmet shells 1 can also be adjusted freely. Use of the head massage device is very flexible and convenient, so that different use requirements of a majority of users can be met.

What is claimed is:

1. A head massage device, comprising two semi-spherical helmet shells symmetrically arranged side by side; each of the two semi-spherical helmet shells is provided with an eye-nose-mouth outlet hole and an ear outlet hole; front ends of the two semi-spherical helmet shells as well as rear ends of the two semi-spherical helmet shells are in each case connected to each other via at least one binding belt, so that the two semi-spherical helmet shells are connected as a whole; a work cavity that can be narrowed and tightened by said at least one binding belt between the front ends of the two semi-spherical helmet shells and said at least one binding belt between the rear ends of the two semi-spherical helmet shells is formed between the two semi-spherical helmet shells; the head massage device also comprises two ultrasonic vibrators and a plurality of massage heads; a plurality of through holes spaced apart from one another evenly by a same distance are formed on each of the two semi-spherical helmet shells; each of the plurality of massage heads is detachably and adjustably mounted in a respective one of the through holes via threaded connection; the two ultrasonic vibrators are mounted on the two semi-spherical helmet shells respectively, and when powered on, each of the two ultrasonic vibrators drives all the massage heads on a corresponding one of the two semi-spherical helmet shells to synchronously perform high-frequency vibratory massage.

2. The head massage device of claim 1, wherein a concave cavity is formed in the middle of each of the two semi-spherical helmet shells; each concave cavity is disposed with a corresponding one of the two ultrasonic vibrators, and a cover for protecting the corresponding one of the ultrasonic vibrators is provided for each concave cavity to cover an opening of each concave cavity.

3. The head massage device of claim 2, wherein a control panel is disposed on only one cover; a control circuit board electrically connected to a corresponding one of the two ultrasonic vibrators and said control panel is disposed on an inner side of each cover.

4. The head massage device of claim 3, wherein each cover is further provided with a power interface electrically connected to a corresponding control circuit board.

5. The head massage device of claim 1, wherein each of the plurality of massage heads comprises a massage part with a surface featuring a plurality of massage protrusions, a screw part having one end connected to the massage part, and two tightening nuts; the screw part is selectively inserted into one of the through holes, and the two tightening nuts are screwed onto the screw part on both sides of said one of the through holes respectively, thereby allowing the screw part to be detachably and adjustably installed into said one of the through holes.

6. The head massage device of claim 5, wherein a drug supply channel is provided on each of the plurality of massage heads penetrating from the surface of the massage part provided with the plurality of massage protrusions all the way through said one end of the screw part along an axial direction of the screw part through another end of the screw part; said another end of the screw part distal from the massage part is also provided with an interface part connected to the drug supply channel.

7. The head massage device of claim 6, wherein the massage part is also provided with a recess, and the drug supply channel penetrates through a bottom surface of the recess; the plurality of massage protrusions are arranged circumferentially around the recess.

8. The head massage device of claim 1, wherein said at least one binding belt connecting the front ends of the two semi-spherical helmet shells comprises two binding belts, and said at least one binding belt connecting the rear ends of the two semi-spherical helmet shells comprises two binding belts, therefore a total number of binding belts provided is four.

9. The head massage device of claim 1, wherein each binding belt comprises a connecting belt disposed on one of the two semi-spherical helmet shells, and a binding belt ring disposed on another one of the semi-spherical helmet shells; a hook and loop fastener is disposed on an outer side surface of the connecting belt; one end of the connecting belt passes through the binding belt ring and is then folded back and adhered back to the outer side surface of the connecting belt.
